(19) United States
(12) Patent Application Publication
(10) Pub. No.: US 2006/0215235 A1
(43) Pub. Date: Sep. 28, 2006

(54) Scanner with an adjustable upper casing

(76) Inventor: Hsien-Chien Li, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/306,038

(22) Filed: Dec. 14, 2005

(30) Foreign Application Priority Data
Dec. 14, 2004 (TW) 093138796

(51) Int. Cl. H04N 1/04

(52) U.S. Cl. 358/474

(57) ABSTRACT

A scanner includes a housing including a first slot, a platform installed on the housing for supporting a document, and an upper casing installed above the platform and rotatably connected to the housing. The upper casing includes a second slot. The scanner further includes a main hinge, connected between the housing and the upper casing. One end of the main hinge is fixed to the upper casing and the other end of the main hinge is positioned within the first slot. The upper case and the housing are connected via the main hinge. The scanner further includes a sub-hinge, connected between the housing and the upper casing, including a shaft and a body. The shaft is installed within the second slot, and the body is installed within the first slot in a slidable manner against the main hinge.

### BACKGROUND OF THE INVENTION

1. Field of the Invention

The present invention relates to a scanner, more particularly, to a scanner with an adjustable upper casing capable of pressing a document.

2. Description of the Prior Art

Scanners are common peripheral nowadays. Scanners can be utilized to scan a document to produce corresponding data and the scanner can also be utilized to convert images of photographs or media into data. The scanner has become an important tool for converting digital data. Furthermore, the scanner can also provide other functions, for example, the scanner can transfer image data to other devices such as fax devices, connect to the internet to transfer image data to others through an email format, or connect to a printer to print images, therefore, information can be digitized and put on the Internet for more people to use.

Please refer to FIG. 1. FIG. 1 illustrates an overview diagram of a conventional scanner 10. The scanner 10 comprises a housing 12, a platform 14, a slide 16, a scan module 18, and a light source 20. The platform 14 is installed on the housing 12 for supporting a document and the scan module 18 is capable of sliding back and forth in direction X shown in FIG. 1. The scan module is installed on the slide 16, for scanning the light reflected by the light source 20 to generate a corresponding image signal of the document. When the scanner 10 is performing a scan, the scan module 18 will move on the slide 16 to scan the document. After the scanner 10 completes a scan, the scan module 18 will return to a predetermined location on the slide 16 and is put on standby. The scanner 10 further comprises an upper casing 22 for pressing the document.

Please refer to FIG. 2. FIG. 2 illustrates a diagram of a document 24 placed on the platform 14 of the scanner 10. If the document 24 is a thick book, the upper casing will be lifted by the document 24 such that the document 24 cannot be pressed completely flat onto the platform 14.

The scan module 18 comprises an important key component of the scanner 10 that is called an image sensitizing component. The image sensitizing component is a contact image sensor (CIS) or a charged coupled device (CCD). The sensitizing component functions as a light receiving device for an image scanner to digitize the received letterings and pictures. Generally, the CIS depth of field is very shallow, meaning that while scanning the document, the document cannot be too far away from the platform 14. In other words, the proximity of the scanning document and the platform 14 is very important. As shown in FIG. 2, when the document 24 cannot be pressed completely flat on the platform 14, the images or letterings scanned will be distorted especially the middle part of the document. Therefore, improving the quality of scanning in situations were the scanning document cannot be pressed completely flat is an important issue.

### SUMMARY OF THE INVENTION

One embodiment of the claimed invention relates to a scanner capable of pressing a document, the scanner comprising: a housing comprising a first slot; a platform, installed on the housing, for supporting a document; an upper casing, installed above the platform and rotatably connected to the housing, the upper casing further comprises a second slot; a main hinge, connected between the housing and the upper casing, wherein one end of the main hinge is fixed to the upper casing and another end is positioned within the first slot; a sub hinge, connected between the housing and the upper casing, the sub hinge comprising a shaft and a body, the shaft installed within the second slot and the body installed within the first slot in a slidable manner against the main hinge.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an overview diagram of a conventional scanner.

FIG. 2 illustrates a diagram of a document placed on a platform of a conventional scanner.

FIG. 3 illustrates a diagram of a scanner according to the present invention.

FIG. 4 illustrates a diagram of a hinge mechanism of the scanner.

FIG. 5 illustrates a lateral diagram of a main hinge, a sub hinge, and a U groove structure when an upper case 42 is lifted.

FIG. 6 illustrates a lateral diagram of a main hinge, a sub hinge, and a U groove structure when an upper case is placed down.

FIG. 7 illustrates a diagram of a hinge device of the scanner when an upper case is placed down and a document is not placed onto a platform.

FIG. 8 illustrates a diagram of a hinge device of a scanner when an upper casing is lifted to a certain angle and a document is not placed onto a platform.

FIG. 9 illustrates a diagram of a hinge device of the scanner when an upper casing is lifted up to its fully extended (i.e., open) position and a document is not placed onto a platform.

FIG. 10 illustrates a diagram of a hinge device of a scanner when an upper casing is lifted up to a certain angle pressing a document on a platform.

FIG. 111 illustrates a diagram of a hinge device of a scanner when an upper casing is placed down completely onto a document.

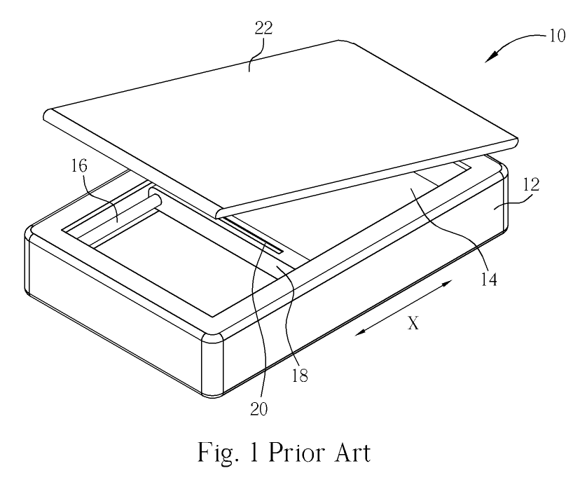

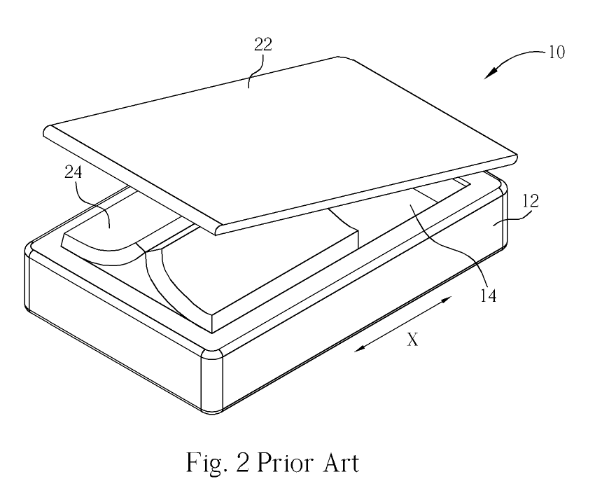

FIG. 12 illustrates a diagram of a document placed on a platform of a scanner.

FIG. 13 illustrates a hinge mechanism according to the second embodiment.

FIG. 14 illustrates a hinge mechanism according to the third embodiment.

FIG. 15 illustrates a diagram of the scanner without a sub hinge.

FIG. 16 illustrates a diagram of a scanner using a main hinge as a hinge mechanism.

### DETAILED DESCRIPTION

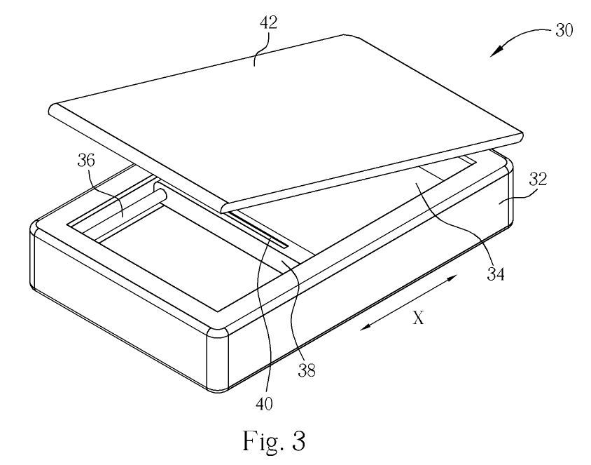

Please refer to FIG. 3. FIG. 3 illustrates a diagram of a scanner 30 according to the present invention. The scanner 30 comprises a housing 32, a platform 34, a slide 36, a scan module 38, and a light source 40. The platform 34 is installed on the housing 32 for supporting a document, and the scan module 38, slidable in the X direction, is installed on the slide 36, for scanning the light reflected by the light source 40 to generate a corresponding image signal of the document. When the scanner 30 is performing a scan, the scan module 38 will move on the slide 36 to scan the document and when the scanner 30 completes a scan, the scan module 38 will return to a predetermined location on the slide 36 and is put on standby. The scanner 30 further comprises an upper casing 42 for pressing the document.

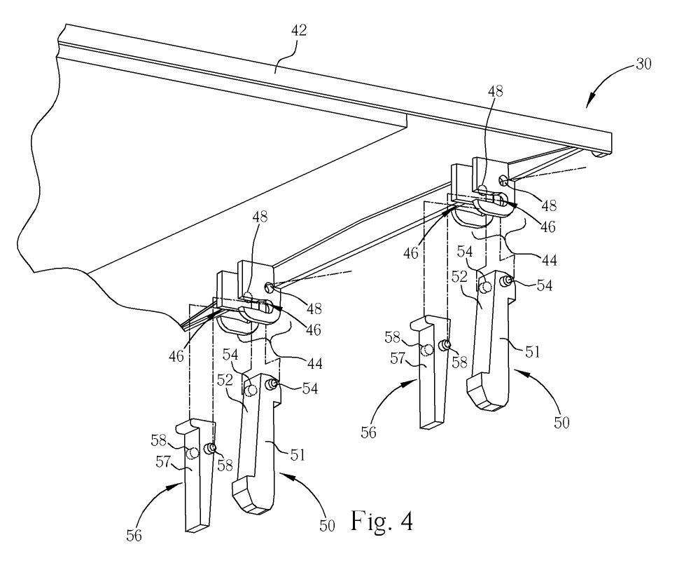

Please refer to FIG. 4. FIG. 4 illustrates a diagram of a hinge mechanism of the scanner 30. The scanner 30 comprises two U groove structures 44 installed at two ends of the upper casing 42. Each U groove structure 44 comprises two second slots 46 and two openings 48. The U groove structure can be integrated on the upper casing 42, or can be coupled to the upper casing 42 by other mechanisms. The scanner 30 further comprises a main hinge 50, width of a body 51 of the main hinge 50 is narrower at the top and wider at the bottom. Moreover, on the body 51 a depressed area 52 (i.e., a slot) is formed. The main hinge 50 comprises two fixed shafts 54 installed in the openings 48 of the U groove structure 44 such that the U groove structure 44 moves corresponding to the main hinge 50. The scanner 30 further comprises a sub hinge 56, width of of a body 57 of the sub hinge 56 is wider at the top and narrower at the bottom. To be more specifically, the space formed by the depressed area 52 of the main hinge 50 fits the shape of the body 57. Therefore the sub hinge 56, installed within the depressed area 52 of the main hinge 50, can slide up and down along the body 51 of the main hinge 50. The sub hinge 56 comprises two shafts 58 installed within the second slot 46 in a sliding manner, when the U groove structure 44 is moving corresponding to the main hinge 50, the shaft 58 is led by the U groove structure 44 to move within the second slot 46.

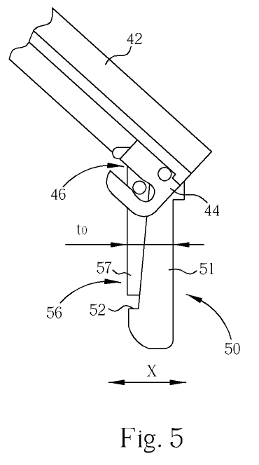

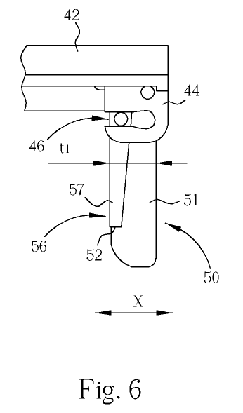

Please refer to FIG. 5 and FIG. 6. FIG. 5 illustrates a lateral diagram of the main hinge 50, the sub hinge 56, and the U groove structure 44 when the upper casing 42 is lifted. FIG. 6 illustrates a lateral diagram of the main hinge 50, the sub hinge 56, and the U groove structure 44 when the upper casing 42 is placed down. In this embodiment, the width of a bottom end of the sub hinge 56 is slightly greater than that of the end of the depressed area 52 of the main hinge 50. As the main body 57 of the sub hinge 56 moves down and has contact against the bottom of the depressed area 52, a side of the sub hinge 56 protrudes out more than a side of the main hinge 50. Furthermore, the wedge structure of the main hinge 50 is narrower at the top and wider at the bottom and the wedge structure of the sub hinge 56 is wider at the top and narrower at the bottom. When the sub hinge 56 slides from top to bottom along the body 51 of the main hinge 50, the whole width formed by the main hinge 50 and the sub hinge 56 widens until the body 57 of the sub hinge 56 moves down and has contact against the bottom of the depressed area 52, the whole width (in direction X) formed by the main hinge 50 and the sub hinge 56 is greatest compared to that in other situations. Looking at FIG. 5 and FIG. 6, when the upper casing 42 is lifted to a certain angle, the width of a cross section of the main hinge 50 and the sub hinge 56 t0 becomes smaller than the width of the cross section of the main hinge 50 and the sub hinge 56 t1 when the upper casing 42 is placed down, which means that when the sub hinge 56 moves up corresponding to the main hinge 50, the width of the cross section of the main hinge 50 and the sub hinge 56 becomes smaller, and when the sub hinge 56 moves down corresponding to the main hinge 56, the width of the cross section of the main hinge 50 and the sub hinge 56 becomes greater.

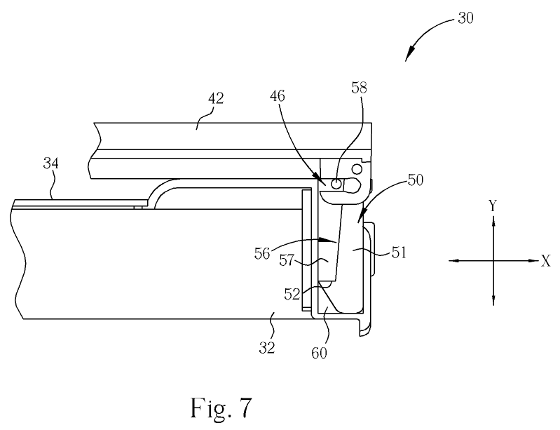

Please refer to FIG. 7. FIG. 7 illustrates a diagram of the hinge device of the scanner 30 when the upper case 42 is placed down and a document is not placed onto the platform 34. The housing 32 of the scanner 30 comprises a first slot 60 and a main hinge is installed within the first slot 60, the body 57 of the sub hinge 56 is slidable along the body 51 of the main hinge 50 and is installed within the first slot 60. When the uppercasing 42 is placed horizontally to the platform 34 without any document placed, the shaft 58 of the sub hinge 56 moves down to contact against the bottom of the depressed area 52, so that the main hinge 50 and the sub hinge 52 will fit tightly and placed at the bottom of the first slot 60.

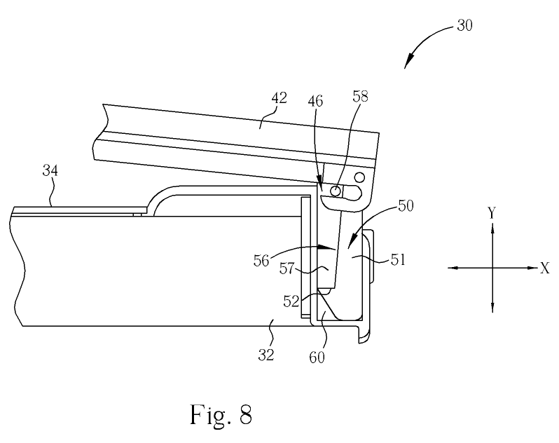

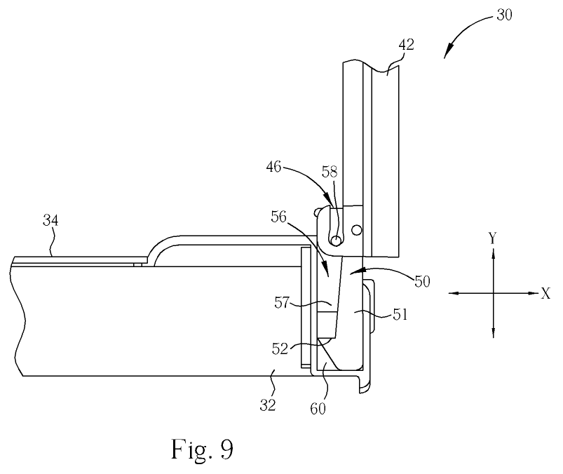

Please refer to FIG. 8 and FIG. 9. FIG. 8 illustrates a diagram of the hinge device of the scanner 30 when the upper casing 42 is lifted to a certain angle and a document is not placed onto the platform 34. FIG. 9 illustrates a diagram of the hinge device of the scanner when the upper casing 42 is lifted up to its fully extended (i.e., open) position and a document is not placed onto the platform 34. When the upper casing 42 is lifted away from the platform 34, the shaft 58 of the sub hinge 56 moves within the second slot 46, the sub hinge 56 moves up (direction Y) relative to the main hinge 50; when the upper casing 42 is perpendicular to the platform 34, the shaft 58 of the sub hinge 56 is at the most inner end of the second slot 46, and the sub hinge 56 moves up to the top position corresponding to the main hinge 50. As shown in FIG. 8 and FIG. 9, as the document is not placed onto the platform 34, and the main hinge 50 will not be lifted up and will be positioned at the bottom of the first slot 60.

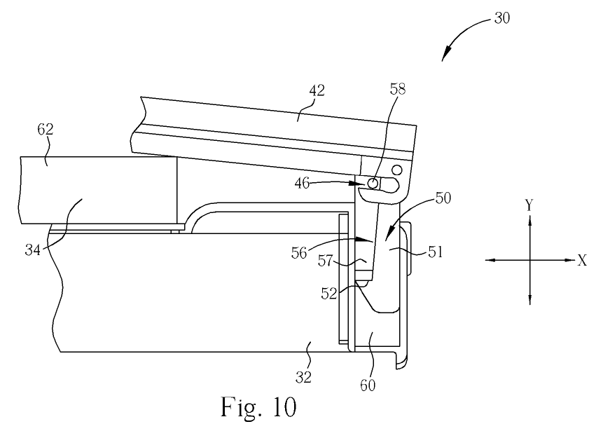

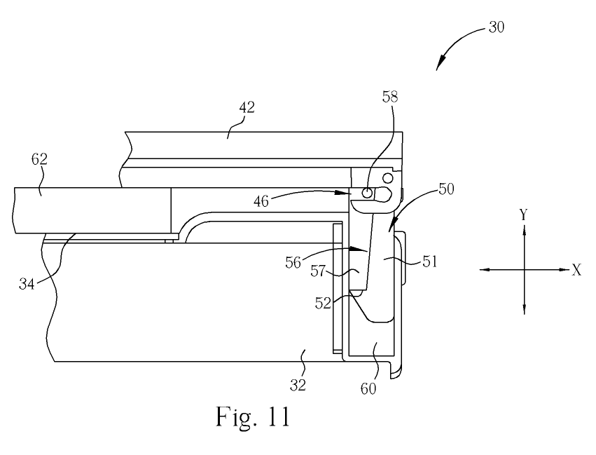

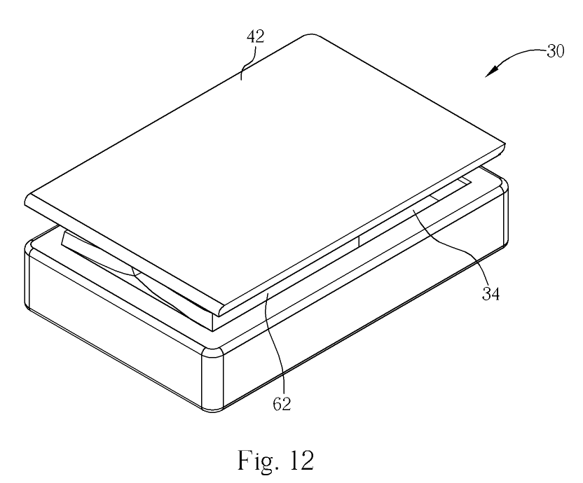

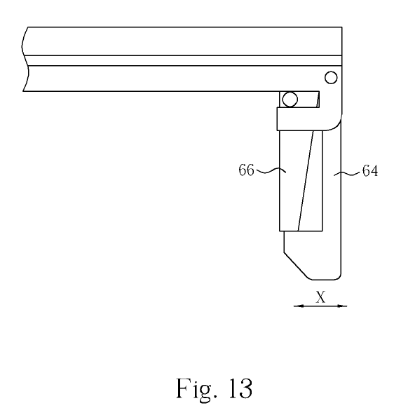

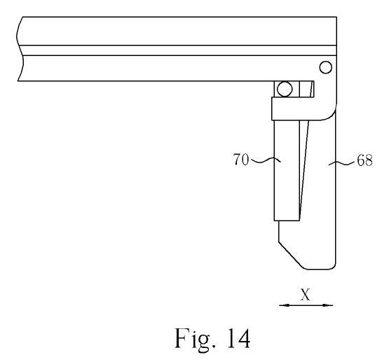

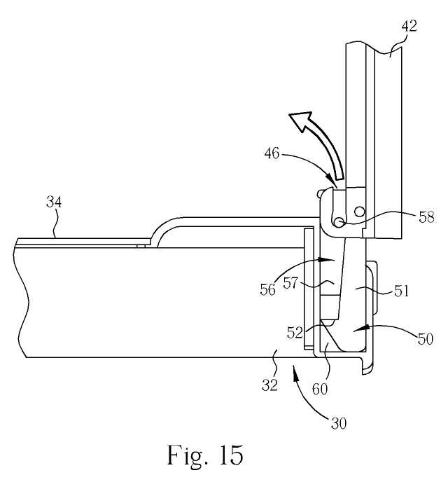

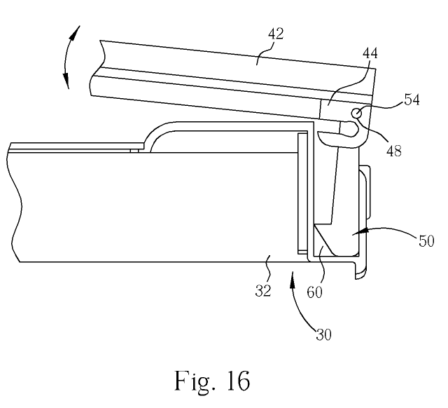

Please refer to FIG. 10 and FIG. 11. FIG. 10 illustrates a diagram of the hinge device of the scanner 30 when the upper casing 42 is lifted up to a certain angle pressing the document 62 on the platform 34. FIG. 11 illustrates a diagram of a hinge device of the scanner 30 when the upper casing 42 is placed down completely onto the document 62. If there is a thick document such as a book, when the book is placed onto the platform 34 of the scanner 30 to perform a scan, and the upper casing 42 is placed down on the platform 34, the thickness of the document 62 will cause the main hinge 50 to rise in the first slot 60 so that the gap between the upper casing 42 and the platform 34 is approximately the same with the thickness of the document 62; at the same time, as the upper casing 42 is moving towards the platform 34, the shaft 58 of the sub hinge 56 again moves within the second slot 46 and the sub hinge 56 moves downwards relative to the main hinge 50, which means that the main hinge 50 and the sub hinge 56 move in opposite directions. When the upper casing 42 is placed down horizontally to the platform 34, the shaft 58 of the sub hinge 56 moves to the most outer end of the second slot 46, and the sub hinge 56 moves down and contacts against the bottom of the depressed area 52, which means that the main hinge 50 and the sub hinge 56 fit tightly. The document 62 is tightly pressed on the platform 34, the gap between the upper casing 42 and the platform 34 is approximately smaller than the thickness of the document 62 as the document is being pressed down, the main hinge 50 will move up perpendicularly to a highest position so that the gap of the upper casing 42 and the platform 34 is approximately smaller than the original thickness of the document 62.

Regarding the combination of the first slot 60 of the housing 32 and the sub hinge 56 of the main hinge 50, the whole width of the main hinge 50 and the sub hinge 56 at direction X can be set to be slightly greater than the width of the first slot 60 of the housing 32. The main hinge 50 and the sub hinge 56 can be made of elastic material such as plastic. When the main hinge 50 and the sub hinge 56 are installed within the first slot 60, the main hinge 50 and the sub hinge 56 being compressed by the housing 32 will generate a certain degree of strain. When the upper casing 42 is moving towards to the platform 34, the body 57 of the sub hinge 56 slides from top to bottom in the first slot 60 along the body 51 of the main hinge 50, so that the whole width of the main hinge 50 and the sub hinge 56 at direction X will increase. It means that the strain generated from compression of the main hinge 50 and the sub hinge 56 by the housing 32 will also increase, thus this will cause the proximity of the main hinge 50, the sub hinge 56, and the first slot 60 to increase. Therefore, the fraction between the main hinge 50, sub hinge 56 and the first slot 60 will also increase, and it is more difficult to move the upper casing 42 towards the platform 34. If the body 57 of the sub hinge 56 moves from bottom to top along the body 51 of the main hinge 50 in the first slot 60, the whole width of the main hinge 50 and the sub hinge 56 at direction X will decrease, which means that the strain generated from compression of the main hinge 50 and the sub hinge 56 by the housing 32 will also decrease. This will cause the proximity of the main hinge 50, the sub hinge 56, and the first slot 60 to decrease and it is easier to move the upper casing 42 towards the platform 34 and the fraction between the sub hinge 56 and the first slot 60 will also decrease. In the above-mentioned, as the width of the bottom end of the sub hinge 56 is slightly greater than the width of the depressed area 52 of the main hinge 50, the main hinge 50 and the sub hinge 56 can fit tightly and install within the first slot 60 of the housing 32. The main idea of design of the structure of the main hinge 50 and the sub hinge 56 is to make the whole width of the main hinge 50 and the sub hinge 56 at direction X to be greater than the width of the first slot 60 of the housing 32, so that the main hinge 50 and the sub hinge 56 can fit tightly in the first slot 60. To conclude, the structure of the main hinge 50 and the sub hinge 56 is not limited to the embodiments disclosed above; the structure is made to reach the goal mentioned above.

Please refer to FIG. 11 and FIG. 12. FIG. 12 illustrates a diagram of the document 62 placed on the platform 34 of the scanner 30. When a user places a thick document 62 such as a book onto the platform 34 of the scanner 30 to perform a scan, the upper casing 42 is moved towards the platform 34, from the above-mentioned, when the upper casing 42 is moving towards the platform 34, the friction of the main hinge 50, sub hinge 56 and the first slot 60 will gradually increase such that the main hinge 50 and the sub hinge 56 will gradually become tightly wedged within the first slot 60, the strength is able to resist the upper casing 42 moving away from the platform 34. When the upper casing 42 is pressed down on and is horizontal to the platform 34 and the document 62 is also pressed tightly on the platform 34, the gap of the upper casing 42 and the platform 34 is approximately the same with the thickness of the document 42, hence a best ideal scan can be accomplished.

The hinge device of the present invention can be represented using other different forms of structure as long as when the sub hinge slides relatively to the main hinge, the width of the main hinge and the sub hinge can change according to the direction of movement. Please refer to FIG. 13 and FIG. 14. FIG. 13 illustrates a hinge mechanism according to the second embodiment. FIG. 14 illustrates a hinge mechanism according to the third embodiment. As shown in FIG. 13, width of a body of a main hinge 64 is uniform, and width of a body of a sub hinge 66 is wider at the top and narrower at the bottom. When the body of the sub hinge 66 is sliding downwards along the body of the main hinge 64, the width of the main hinge 64 and the sub hinge 66 in direction X will gradually increase. Relatively, if the body of the sub hinge 66 is sliding upwards along the body of the main hinge 64 in the direction X will gradually decrease. As shown in FIG. 14, width of a body of a main hinge 68 is narrower at the top and wider at the bottom, and width of a body of a sub hinge 70 is uniform. When the body of the sub hinge 70 is sliding downwards along the body of the main hinge 68, the width of the main hinge 68 and the sub hinge 70 in direction X will gradually increase. Relatively, if the body of the sub hinge 66 is sliding upwards along the body of the main hinge 64 in the direction X will gradually decrease. The operational functions of other component of the second and third embodiment are similar to the first embodiment, therefore it will not be further mentioned.

When the thickness of the scanning document is thin and is not required to be pressed down then the sub hinge can be detached from the scanner. When the sub hinge is detached the upper casing of the present invention will function like a conventional upper casing. Please refer to FIG. 15 and FIG. 16. FIG. 15 illustrates a diagram of the scanner without a sub hinge 56. FIG. 16 illustrates a diagram of a scanner 30 using a main hinge 50 as a hinge mechanism. The shaft 58 of the sub hinge 56 can move out of the second slot 46 of the upper casing 42 when the upper casing 42 and the housing 32 are approximately perpendicular and the sub hinge 56 can be detached from the scanner 30. As shown in FIG. 16, the upper casing 42 attaches to the opening 49 of the U groove structure 44 through the fixed shaft. Once attached, the main hinge can now move freely and is not restricted to the main hinge 50 and the sub hinge 56 moving in the first slot 60, hence the upper casing 42 does not have the function of pressing document.

In comparison to the prior art, the present invention of a scanner capable of pressing a document or book onto a platform, overcomes the defect resulting from the scanning of a book when the images or letterings scanned will be distorted, especially the middle part of the document, hence the present invention greatly improves on the quality of scanning.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A scanner capable of pressing a document, the scanner comprising:
a housing comprising a first slot;
a platform, installed on the housing, for supporting a document;
an upper casing, installed above the platform and rotatably connected to the housing, the upper casing further comprising a second slot;
a main hinge, connected between the housing and the upper casing, wherein one end of the main hinge is fixed to the upper casing and another end is positioned within the first slot; and
a sub hinge, connected between the housing and the upper casing, comprising a shaft and a body, the shaft installed within the second slot and the body installed within the first slot in a slidable manner against the main hinge.

2. The scanner of claim 1 wherein the main hinge and the sub hinge are slidable against each other and the shaft of the sub hinge slides between a first position and a second position within the second slot.

3. The scanner of claim 2 wherein when the upper casing is rotating away from the platform, the shaft of the sub hinge moves towards the second position of the second slot, and the body of the sub hinge slides upwards along the main hinge.

4. The scanner of claim 2 wherein when the upper casing is rotating toward the platform, the shaft of the sub hinge moves towards the first position of the second slot, and the main body slides downwards along the main hinge.

5. The scanner of claim 4 wherein the document has a thickness, when the upper casing is sliding towards the platform, the main hinge moves in a vertical direction in the first slot corresponding to the thickness of the document.

6. The scanner of claim 1 wherein a depressed area is formed on the main hinge, a shape of the body of the sub hinge matching a shape of the depressed area.

7. The scanner of claim 6 wherein the first slot comprises a first width, and the main body of the sub hinge is wedge shaped, the main hinge and the sub hinge together form a second width when the depressed area of the main hinge receives the body of the sub hinge, and the second width is approximately greater than the first width.

8. The scanner of claim 7 wherein the main hinge is made of an elastic material.

9. The scanner of claim 7 wherein the sub hinge is made of an elastic material.

10. The scanner of claim 1 wherein the main hinge is uniform in width, the sub hinge is wider at the top and narrower at the bottom.

11. The scanner of claim 1 wherein the main hinge is narrower at the top and wider at the bottom, the sub hinge is wider at the top and narrower at the bottom.

12. The scanner of claim 1 wherein a width of the main hinge is narrower at the top and wider at the bottom, the sub hinge is uniform in width.

13. The scanner of claim 1 wherein the shaft of the sub hinge is detachable from the second slot of the upper casing.

14. The scanner of claim 1 wherein the main hinge comprises a fixed shaft to hinge with the upper case.
